(19) United States
(12) Patent Application Publication
(10) Pub. No.: US 2025/0200286 A1
(43) Pub. Date: Jun. 19, 2025

(54) SYSTEMS AND METHODS FOR AN AUTOMATED TOOL FOR STIX REPORT GENERATION FROM THREAT INTELLIGENCE TEXT

(71) Applicant: Hamad Bin Khalifa University (HBKU), Doha (QA)

(72) Inventors: Husrev Taha Sencar, Doha (QA); Ahmed Lekssays, Doha (QA); Ting Yu, Doha (QA)

(21) Appl. No.: 18/980,609

(22) Filed: Dec. 13, 2024

Related U.S. Application Data
(60) Provisional application No. 63/610,945, filed on Dec. 15, 2023.

(51) Int. Cl. G06F 40/295; G06F 21/56; G06F 40/205

(52) U.S. Cl. CPC G06F 40/295; G06F 21/56; G06F 40/205

(57) ABSTRACT

The present disclosure relates to an automated tool for STIX report generation from threat intelligence text. In a second aspect of the present disclosure, a method of using an automated tool for STIX report generation from threat intelligence text.

### PRIORITY CLAIM AND CROSS-REFERENCE TO RELATED APPLICATIONS

The present application claims the benefit of U.S. Provisional Application No. 63/610,945 filed Dec. 15, 2023, which is incorporated herein by reference in its entirety.

### BACKGROUND

A large amount of cyber threat intelligence (CTI) data is available in unstructured and semi-structured text. This information is typically compiled together by domain expert analysts in order to understand threats, exploits, attack vectors, and adversaries. The knowledge derived from this largely open-sourced information is indispensable for security teams, as it enables them to continually assess and enhance their security posture. Additionally, it plays a crucial role in supporting cyber operations by ensuring the availability of current detection and protection systems that align with the fast-evolving threat landscape. However, it is very time- and labor-consuming to manually gather relevant information from the large body of threat intelligence data and evaluate it in a timely manner. However, the task of extracting CTI information from textual sources and transforming it into machine-readable, standardized formats still poses challenges as it remains a time-consuming and expert-driven process.

These formats and solutions fail to generalize to due to the complexity of cybersecurity text, even those using standardized intelligence-sharing formats like STIX. First, some critical cybersecurity entities are hard to be detected with RegEx rules such as registry keys. Second, cybersecurity entities vary from one report to another, so it is impractical to compile a closed list of keywords to be used to detect them. They are usually proper nouns that denote malware names, attack tool names, identities, etc. Third, these works do not follow a standard that defines the entities to be extracted knowing that extracting some entities is a challenging task that requires context understanding. Thus, they do not extract important entities such as Mitigations, Infrastructures, Threat Actors, etc. Fourth, identifying relations from CTI reports requires an understanding of the cybersecurity text which NLP pipelines fail to achieve.

Accordingly, there is a need for an automated tool for STIX report generation from threat intelligence text.

### SUMMARY

The present disclosure provides for an automated tool for STIX report generation from threat intelligence text.

According to one non-limiting aspect of the present disclosure, an automated tool for STIX report generation from threat intelligence text.

According to a second non-limiting aspect of the present disclosure, an exemplary embodiment of a method of using an automated tool for STIX report generation from threat intelligence text.

Additional features and advantages are described in, and will be apparent from, the following Detailed Description and the Figures. The features and advantages described herein are not all-inclusive and, in particular, many additional features and advantages will be apparent to one of ordinary skill in the art in view of the figures and description. In addition, any particular embodiment does not have to have all of the advantages listed herein and it is expressly contemplated to claim individual advantageous embodiments separately. Moreover, it should be noted that the language used in the specification has been selected principally for readability and instructional purposes, and not to limit the scope of the inventive subject matter.

### BRIEF DESCRIPTION OF THE DRAWINGS

FIG. 1 shows the architecture of an automated tool for STIX report generation from threat intelligence text, according to an example embodiment of the present disclosure.

FIG. 2 also shows the architecture of an automated tool for STIX report generation from threat intelligence text, according to an example embodiment of the present disclosure.

FIG. 3 shows examples of the overall flow of the system, according to an example embodiment of the present disclosure.

FIG. 4 shows a user dashboard with reports that a user submitted, according to an example embodiment of the present disclosure.

FIG. 5 shows a graph view of a report that a user generated with edit options, according to an example embodiment of the present disclosure.

FIG. 6 shows textual view of an automatically annotated report by the system, according to an example embodiment of the present disclosure.

### DETAILED DESCRIPTION

The present disclosure generally relates to an automated tool for STIX report generation from threat intelligence text.

CTI knowledge extraction has been extensively studied in literature. These works rely on Regular Expressions to extract Indicators of Compromise (IoCs) and NLP pipelines (based on closed lists of keywords) to detect cyber-security related entities. However, these works fail to generalize to due to the complexity of cybersecurity text. First, some critical cybersecurity entities are hard to be detected with RegEx rules such as registry keys. Second, cybersecurity entities vary from one report to another, so it is impractical to compile a closed list of keywords to be used to detect them. They are usually proper nouns that denote malware names, attack tool names, identities, etc. Third, these works do not follow a standard that defines the entities to be extracted knowing that extracting some entities is a challenging task that requires context understanding. Thus, they do not extract important entities such as Mitigations, Infrastructures, Threat Actors, etc. Fourth, identifying relations from CTI reports requires an understanding of the cybersecurity text which NLP pipelines fail to achieve. Finally, using plain large language models (LLMs) without any fine-tuning or processing of cybersecurity text is shown to be impractical.

STIX is one of the leading threat intelligence-sharing standards. It is supported by many vendors such as IBM4, Microsoft5, and Cloudflare6. STIX standard has three types of objects: STIX Domain Objects (SDOs), STIX Relationship Objects (SROs), and STIX Cyber-observable Objects (SCOs).

STIX standard has 19 SDOs, 2 SROs, and 18 SCOs. In evaluation it was determined that some of the SDOs are less critical from an information-sharing and extraction point of view. Those objects that were removed in this study are the following 8 SDOs: Malware Analysis, Campaign, Grouping, Intrusion Set, Note, Opinion, Observed Data, and Report.

STIX models concepts commonly represented in CTI as objects, namely, Attack Pattern, Course of Action, Identity, Indicator, Infrastructure, Location, Malware, Threat Actor, Tool, and Vulnerability. In addition, each object has a set of attributes, such as malware family (for malware), role (for identity), tool type (for tool), etc.

STIX Relationship Objects. In order to link SDOs, STIX introduces the Relationship object that has 3 main components: the source object, the target object, and the relationship type. The latter is predefined by STIX in a relationship matrix that can be extracted from STIX documentation. There are 38 types of relationships including (but not limited to): indicates, targets, uses, exfiltrates to, authored by, communicates with, etc. Every pair of SDOs have their own set of relationship types. For example, a relationship between a Malware object and a Location object is either targets or originates from. It is worth noting that some pairs of SDOs do not have relationships. In addition, STIX defines some relationships between some SCOs and SDOs such as Infrastructure and IPv4 address.

STIX Cyber-observable Objects. The Indicator SDO can have different subtypes which are defined by the SCOs. These include (but are not limited to) Directory, Domain Name, Email address, File, IPv4/IPv6 address, MAC address, URL, and Windows Registry Key. It is worth noting that an Indicator object cannot be defined without defining its subtype that must be chosen from the SCOs listed in STIX documentation.

Large language models (LLMs) are a type of artificial intelligence (AI) that are trained on massive datasets of text and code. They can be used to generate text, translate languages, write different kinds of creative content, and answer questions based on their trained data or a given context. The emerging LLMs are based on transformers, which are a type of neural network architecture. They are particularly well-suited for natural language processing tasks because they can learn long-range dependencies between words. The transformer architecture was first introduced in. It consists of an encoder and a decoder. The encoder takes the input text as input and produces a sequence of hidden states. The decoder then takes these hidden states as input and produces the output text. The encoder and decoder are both composed of self-attention layers. These layers allow the model to learn the relationships between different words in the input text.

Due to their exponential growth, they have found applications across diverse domains, including the realm of cybersecurity. Within this field, they have been utilized for various purposes such as cyber threats detection, explainable cybersecurity, cybersecurity text understanding, vulnerability fixes, and program analysis. This study narrows its focus to the task of understanding cybersecurity text, specifically focusing on the extraction of cybersecurity entities and the identification of relations among them.

Characteristics of Security Text: Domain-Specific Terminology: Threat intelligence reports are primarily intended for security experts who develop and maintain a wide range of security services and functions. As such, the text inherently assumes that the reader possesses a sufficient level of domain expertise to comprehend the intricacies of newly discovered threat behavior without providing redundant details that may be accessible elsewhere in the public domain. For instance, an author of a threat intelligence report may use terms like “payload,” “malware,” and the actual “malware name” interchangeably in the same paragraph, assuming that the reader understands their interrelation. Similarly, a threat actor may be referred to by various names assigned by different security vendors. Furthermore, the author may establish implicit links between entities. For example, when discussing a malware that targets IIS or is written in C#, the assumption is that the reader is familiar with .NET and ASP, as well as the deployment of .aspx files on an IIS server. These nuances present challenges to the effectiveness of conventional NLP pipelines and language models that are primarily constructed based on natural language text accessible to a general audience. This mismatch becomes evident in the form of a distribution shift, as the characteristics of the data used to build such models significantly differ from those of the data used for testing. Consequently, this disparity leads to inferior performance. Addressing these issues becomes vital to enhance the adaptability and overall performance of the models when dealing with specialized threat intelligence reports.

Language Complexity: The primary competency of the author of a threat intelligence report lies in their ability to collect and analyze evidence crucial for understanding threat behaviors. Communicating these findings to other experts does not necessarily demand a concise and crisp writing style. In fact, as demonstrated, threat intelligence reports tend to be quite verbose and lack a specific grammatical structure. Furthermore, they often lack proper punctuation and may contain sentences with missing subjects, objects, or pronouns. The cumulative effect of these complexities makes understanding the context of events challenging for LLMs and renders any inferences derived from such text error-prone.

Use of Mixed Data Formats: Security texts are diverse, containing various types of data such as tables, lists, code snippets, command line arguments, figures, and charts, in addition to the main textual content. Authors often incorporate these different types of data directly into paragraphs without clear delimiters. For example, code snippets or commands may be embedded within paragraphs as regular text, lacking code boxes or syntax highlighting. Tables and charts are employed when information can be conveyed more effectively than using text alone. As a result, to extract comprehensive knowledge from a threat intelligence text, it becomes crucial not only to understand the textual content but also to transform these alternative data formats into text as part of a pre-processing step. For instance, some charts show the attack timeline and the employed techniques or the evolution of malware variations. In addition, some figures contain snippets from the reversed binaries, which may contain crucial information like malware kill switches. Moreover, command lines and code snippets contain valuable information that are usually hardcoded in the malware's source code such as private keys, encryption algorithms, domain names, etc. Hence, it is important to consider these artifacts as they convey information that might be helpful in containing malware. Regarding tables, they are converted into tab-separated lines. In other words, they are not put into sentences. However, this representation does not have verbs and, thus, it makes relation extraction complicated. Representing tables in a more suitable format remains future work.

Entity Naming Inconsistency: Entities can exhibit inconsistent naming conventions. For example, an author may use a malware name, its antivirus (AV) detection name, and different variations of the malware name (e.g., uppercase and lowercase) interchangeably. In addition, threat actors might be known with different names that could be all used interchangeably in a single article. Consequently, a single entity may be extracted as multiple separate entities. To address these ambiguities and ensure accuracy, it is crucial to perform an entity resolution step before undertaking more complex knowledge extraction tasks.

Compatibility with Security Tasks: Today's LLMs are trained on vast amounts of text data, spanning trillions of tokens from diverse sources, which also includes cybersecurity domain information. Despite this exposure, LLMs do not exhibit the same level of comprehension when processing security text as they do with natural language text. This limitation can be attributed to two potential reasons. Firstly, security text constitutes only a small fraction of the overall training data for LLMs. When combined with the characteristics that render it relatively out-of-distribution, this leads to a weaker grasp of security-related notions. Secondly, the vocabulary used for tokenizing LLM inputs is not optimized for fully understanding security concepts. Security text often contains specialized terms, such as IoCs like registry keys, file hashes, and various abbreviations denoting system-level concepts, which are not commonly found in natural language text. Additionally, the tokenization strategy, which governs the splitting of everyday words into short word pieces (tokens) based on occurrence frequency and delimiters, may not generate informative elements for LLMs when dealing with security text, such as hashes and IP addresses. Experiments demonstrate that prompting an LLM with security text while replacing such IoCs with placeholder terms can reduce processing time significantly. This approach enhances the efficiency of LLMs in dealing with security-specific language structures.

LLMs Settings: LLMs offer several parameters that can be tuned to optimize their performance for specific tasks, including temperature, top-k, top-p, and maximum new tokens. Firstly, the temperature parameter controls the creativity of the model. By setting it to values higher than zero, the probability distribution of output tokens is modified to boost the probabilities of otherwise unlikely tokens. However, for tasks that require generating answers from a given knowledge base, limiting the model's creativity is necessary, as it ensures the model adheres closely to the existing knowledge. Secondly, the top-k parameter instructs the model to select the next token from the top ‘k’ tokens in its sorted list based on probabilities. Setting top-k to 1 allows the model to pick only the top token, thus enforcing strict selection. Thirdly, top-p is similar to top-k, but it offers more dynamism. Instead of selecting the top ‘k’ tokens, it picks tokens based on the sum of their probabilities. This parameter is often used to exclude tokens with lower probability, making it helpful for tasks where high-confidence predictions are desired. For example, setting top-p to 0.20 would exclude the bottom 80% of probable tokens. Hence, top-p uses a dynamic probability threshold ‘p’ to select words, resulting in a variable subset of words to choose from at each step while top-k, in contrast, selects from a fixed number ‘k’ of the most probable words, leading to a constant subset of words to choose from at each step. Finally, the maximum new tokens parameter governs the length of the generated output. To optimize this parameter, it is crucial to have an understanding of the expected length of the answers. Reducing the value of this parameter can increase inference speed, making it a useful option for scenarios where shorter responses are preferred.

Prompting: LLMs exhibit sensitivity to the prompt formulation and prompt templates, meaning that querying a model with two different prompts can result in significantly different outputs. To ensure consistent and accurate results, it is crucial to use the prompt templates that were employed during the model's fine-tuning phase. This approach guarantees better alignment with the model's learned behavior and maximizes the accuracy of the generated responses. The prompt templates for each model are public information that can be found in the models' descriptions on Hugging-Face.

### System Overview

Problem Formulation: The task of relation extraction from threat intelligence reports is framed as an inference problem. The report, denoted as D, can be perceived as a document comprising multiple entities, e, interconnected by pairwise relations referred to as rel. Determining the relation rel between two entities, ei and e, relies on the context provided as con(ei, ej). Entities are derived from an unbounded set E={e1, e2, e3, . . . }, with each entity being associated with a specific object type from a closed set O={o1, o2, . . . , om}. These object types encompass a variety of SDOs and SCOs as defined in the STIX standard. Consequently, a function ϕ=E→O is employed to map each entity to its respective object type, denoted as ϕ (e)=o. Similarly, relations are drawn from the closed set of relationships R={rel1, rel2, . . . , reln}, determined by the n types of SROs in the STIX standard. Correspondingly, a text excerpt extracted from the report, specifically mentioning both entities ei and e, forms the context that defines the relationship between the two objects.

A knowledge graph representation is an effective method for capturing the relationships between entities in a document. Consequently, a report can be represented as a graph, where E represents the set of nodes, and the set (ei, e, reli,j) depicts edges portraying relationships between nodes. Thus, the objective is to determine the relationship rel that best connects the two entities, given their context. In other words, it is sought to estimate the following conditional probability:

$$P ( rel \vert con ( {e}_{i} , {e}_{j} ) \text{?} {max}_{rel} P ( rel \vert x , μ ) \text{?} \qquad ( 1 )$$

$$\text{?} \text{indicates text missing or illegible when filed}$$

where x is an input prompt and μ is a language model. To achieve this, the technology devises a text prompt x that encompasses the context of the two entities, their entity types, and the set of possible relationships, defined as:

$$x = ( Ins , con ( {e}_{i} , {e}_{j} ) , ϕ ( {e}_{i} ) , ϕ ( {e}_{j} ) , {ℛ}^{′} ∈ ℛ , Out ) \text{?} \qquad ( 2 )$$

$$\text{?} \text{indicates text missing or illegible when filed}$$

where Ins is the instruction given to the model; co(ei, ej) is the context for the two entities; ϕ(ei) and ϕ(ej) are respective entity types; R′ is the subset of valid relationships between ei and ej; and Out is the indicator specifying the desired format for the output. Subsequently, the LLM μ is prompted with x to discern the most likely relationship between the two objects. Effectively, the LLM computes these probabilities by evaluating the softmax function over a restricted vocabulary, mainly comprising words and tokens that are associated with elements of R.

It is essential to note that each rel∈R is defined between different types of entities. As a result, the success of this approach hinges on accurately identifying all entities and their corresponding types. The entities within D and the function ϕ that assigns entity types can be determined using either RegEx-based entity detection rules, as most entities follow well-defined formats, or by employing a neural network or an LLM to identify objects and their types, as formulated in Eq. (1).

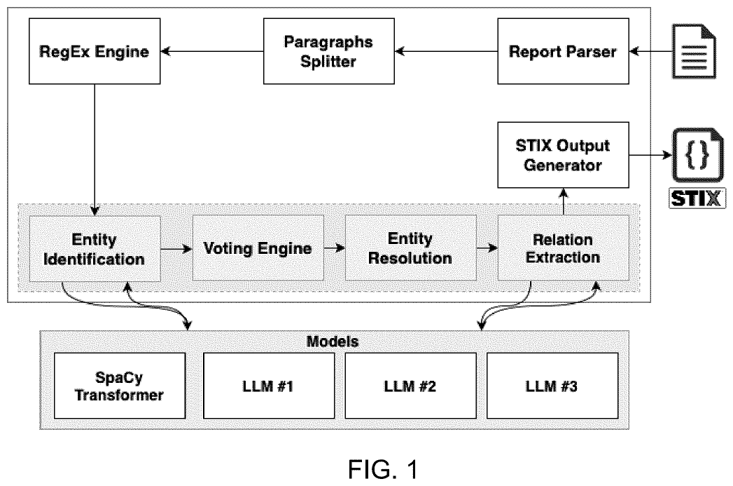

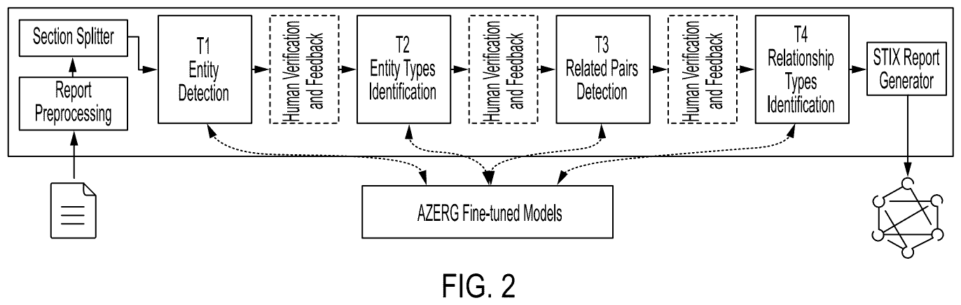

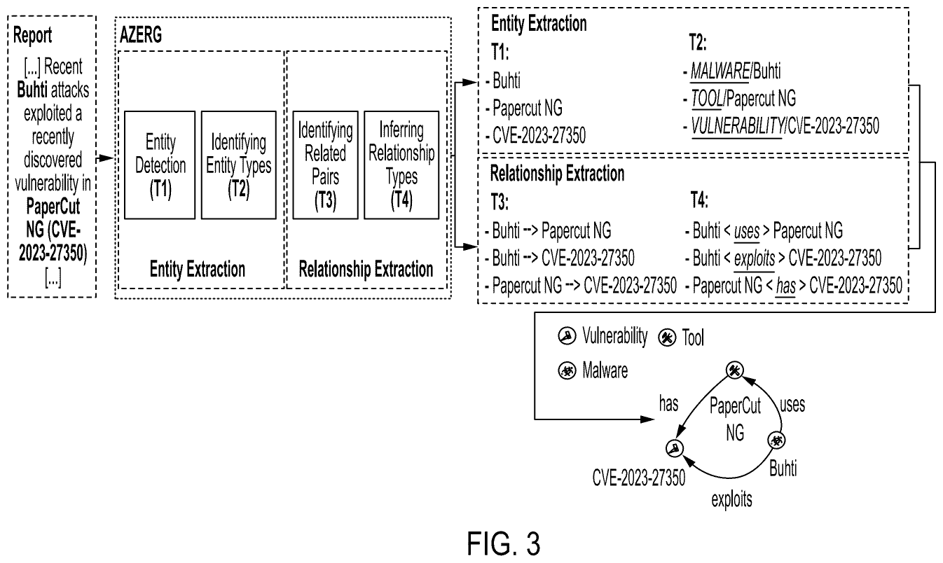

FIG. 1 presents the key components of the disclosed technology. The figure illustrates two primary modules: one for processing and relation extraction (referred to as the main module), and the other for hosting LLMs (the LLM module). Importantly, the main module is designed to be model-agnostic, accommodating various LLMs in parallel and fusing their output to make decisions. The integration of any LLM with the disclosed technology requires the provision of an API endpoint adhering to a pre-defined response format. This enables seamless integration of other models, including closed models such OpenAI models. FIG. 2 also shows the architecture of an automated tool for STIX report generation from threat intelligence text. Moreover, FIG. 3 shows examples of the overall flow of the system, as described below.

Report Parser: This component accepts input in the form of a URL, a PDF document, or a text document, and converts it to plain text, stripping away any formatting except headings HTML tags that are usually used for titles. Given the diverse types of data, including both textual and non-textual content found in CTI reports, tables, and bullet points are also converted to plain text, while images are excluded from the processed text. However, code snippets are retained, as they may contain crucial information such as file names and directory paths. It is important to note that a more specialized processing approach is required to fully comprehend code snippets. Understanding code and images is left as future work.

Section Splitter: This component processes the plain text reports and segments them into paragraphs using HTML headings. CTI reports are organized into sections, each focusing on a specific aspect. As a result, the reports are divided into sections based on the paragraph titles (i.e., HTML heading tags).

Entity Detection (T1): The identification of all SDOs and SCOs described in a report is essential for generating a comprehensive STIX output. Relying solely on regular expressions for this task is inadequate since many entities lack regular forms or syntax. When dealing with SDOs, the primary focus lies in identifying the names of the following SDOs: Attack Pattern, Identity, Location, Malware, Threat Actor, Tool, and Vulnerability, the descriptions of Course of Action objects, and the value and sub-type of Indicator objects. For Infrastructure objects, a closed list encompassing known cloud providers, P2P networks, operating systems, and virtualization systems is compiled. In the case of SCOs, regular expressions are employed to extract IP addresses, domain names, hashes, emails, MAC addresses, and URLs. However, regular expressions cannot reliably identify entities like registry keys and Windows/Linux paths. To address this, LLMs are employed and tailored custom prompts are created to achieve accurate entity identification.

Entity Types Identification (T2): the purpose of this module is to identify the type of each entity detected by Entity Detection (T1), based on the context in which the entity is mentioned. The identification of entity types is crucial for constructing the final STIX graph, as this information determines the potential relationships between entities. This module takes as input the identified entities in T1 and the text passages where they were mentioned. Then, it goes through them individually and asks the model to identify their STIX types. In such instances, this technology relies on the decision of the best8 model used in experiments. This technology refrains from pursuing additional rounds to resolve conflicts to avoid computational overhead and multiple queries to the LLMs. This strategy overall ensures both efficiency and a high level of entity identification accuracy.

Related Pairs Detection (T3): This module identifies pairs of related entities based on a list of entities, their types, and the text passage where they are mentioned. It leverages the STIX relationship matrix, which defines valid pairwise relationships (Structured Relationship Objects or SROs) among all entity types, including Structured Data Objects (SDOs) and Structured Cyber Observables (SCOs). By iterating over all pairs of entity types where an SRO can be defined, the module extracts all possible entity pairs that can be connected through a valid SRO. For each pair, it provides multiple relationship options to determine the valid relationship type describing their interaction. These options include specific relationships from the STIX matrix, as well as “is not related to” and “not sure.” This process is repeated until all SROs associated with valid entity pairs are identified.

LLMs tend to be slow and inaccurate when processing strings that are not in natural language. As a result, when dealing with entities like hashes, IP addresses, MAC addresses, domain names, and cryptocurrency wallets, one replaces them with generic placeholder texts, such as “SHA256 hash”, “IP address”, etc. Additionally, these indicators of compromise are typically listed in tables or as lists without explanatory text, further contributing to the inaccurate performance of LLMs when extracting relationships. For instance, LLMs struggle when extracting the relationship between a hash and malware, resulting in sub-optimal outcomes. To address scenarios where a context cannot be established for an entity, one implements a local search to identify potential entities that may be related to it. When dealing with entities such as IP addresses, MAC addresses, or hashes, one looks for the position of the target entity in question within the input text. Next, one searches for the closest SDO to the target entity in the text and consider that SDO is associated with the target entity. However, in cases where multiple SDOs are within the proximity of a target entity, this technology prompts the LLM to choose the correct SDO that the target entity indicates. This approach enhances the accuracy of relation extraction for the IoCs while also reducing the number of queries to LLMs.

RegEx Engine: As most of the entities contain well-established indicators of compromise (IoCs), they can be extracted efficiently using regular expressions, eliminating the requirement for an LLM. To achieve this, iocparser's7 API is leveraged to extract various IoCs such as URLs, filenames, IP addresses, domain names, file hashes, MITRE ATT&CK IDs, YARA Rules, and ASNs. Additionally, this technology incorporates regular expressions to extract cryptocurrency wallets. Furthermore, at this step, this technology extracts Windows API functions with a hardcoded list since they are predefined.

Human Verification and Feedback: This optional module is integrated into the process to account for the sequential nature of the tasks. After each task, users can review its output and make necessary modifications, such as adding, deleting, or altering the results. This ensures that the adjusted output is accurate and suitable before being passed to the subsequent task.

STIX Output Generator: Upon identifying the entities and extracting relationships in accordance with the STIX standard, one merges them to generate a JSON file that encompasses entities and their relations in STIX format. This file serves as a means for threat intelligence sharing and can be utilized with TAXII9 or any other threat intelligence exchange protocol. Notably, the files logon.aspx and default.aspx are not linked to the .NET and IIS entities. This lack of linkage stems from the absence of an explicit relation within the report. It is evident that the authors of the report assume the reader possesses adequate prior background knowledge concerning this relationship. It is possible to query external services (e.g., VirusTotal for malware hashes) to enhance the generated STIX reports.

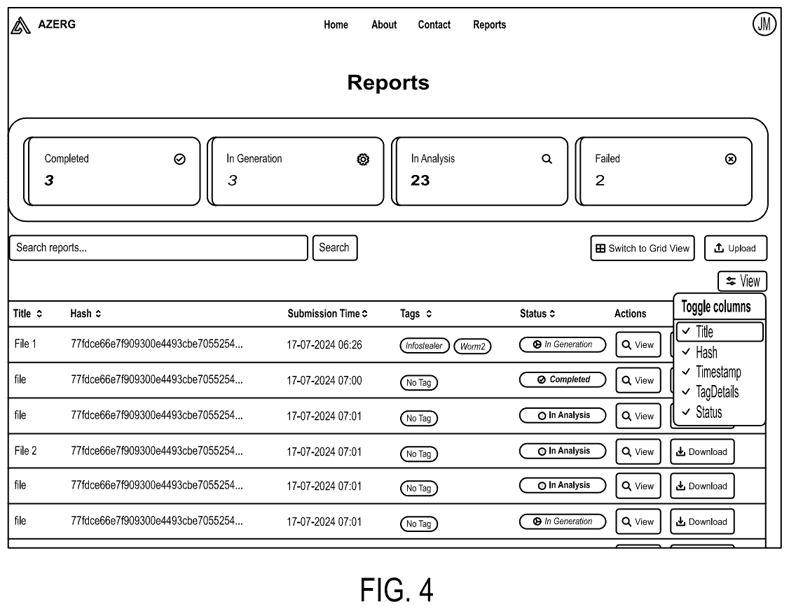

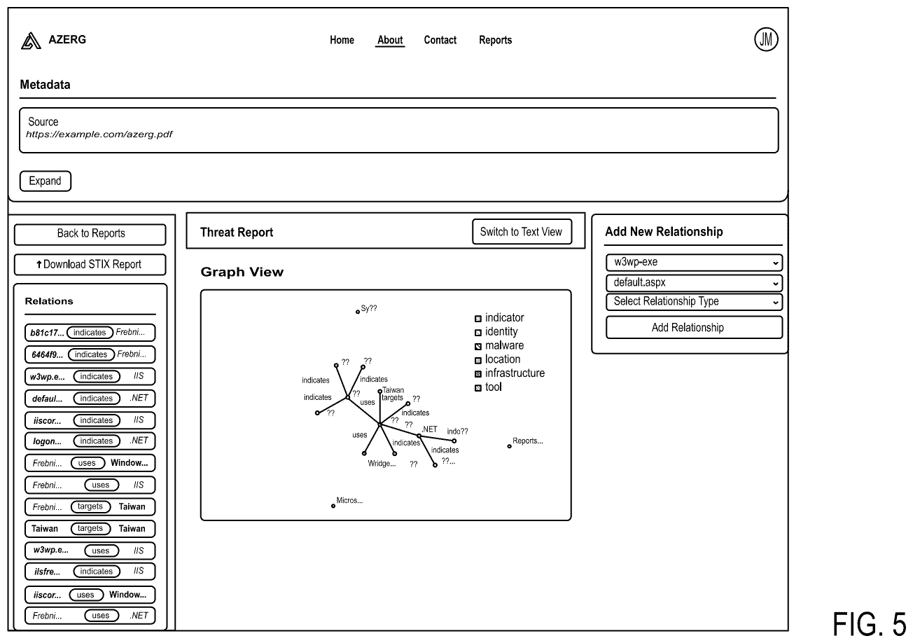

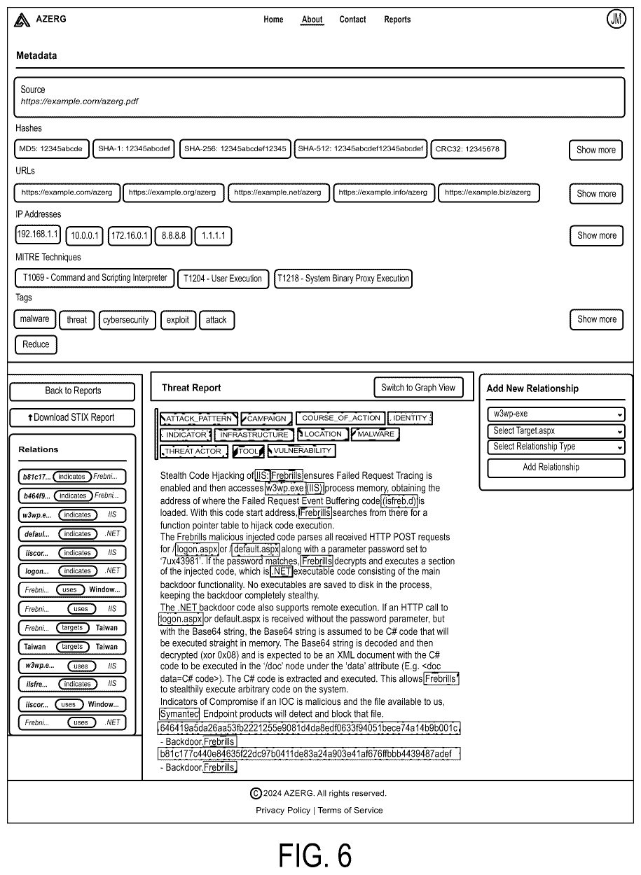

FIG. 4 shows a user dashboard with reports that a user submitted, FIG. 5 shows a graph view of a report that a user generated with edit options, and FIG. 6 shows textual view of an automatically annotated report by the system.

### Datasets

Fine-tuning and testing models for threat knowledge extraction require ground truth annotations aligned with STIX standard definitions. While many threat intelligence vendors provide STIX reports alongside threat analysis, publicly available STIX data is limited, primarily consisting of indicator-type SDOs detectable through regular expressions but lacking essential SROs defining relationships between entities. To address this gap, a new dataset comprising two sources was curated: AZERG Data and AnnoCTRPlus.

AZERG Dataset includes SDOs and SROs extracted from 21 malware campaign reports published by 11 vendors. These reports were selected based on strict criteria to ensure diverse textual elements, such as command lines and code snippets, beyond the scope of regular expression detection. The average report length is 1,650 words, ranging from 757 to 3,400 words.

AnnoCTRPlus builds upon the AnnoCTR dataset by annotating named entities such as organizations, locations, industry sectors, code snippets, hacker groups, malware, tools, time expressions, and adversarial tactics and techniques from 120 CTI reports. Overlaps with STIX-defined entities were manually reviewed and expanded through a two-step process. First, non-STIX entities like “malware” and “attack” were removed, while missing STIX entities such as “indicators” and “courses of action” were added using a combination of regular expressions and manual annotation. Second, SROs, absent in AnnoCTR, were manually annotated. Multi-entity sentences were consolidated using fuzzy string matching, reducing unique passages to 744. The dataset also includes inferred MITRE ATT&CK tactic and technique IDs, retaining only explicitly mentioned attack patterns.

Manual annotation of both datasets was conducted by an expert in offensive security with over a decade of experience, using the Doccano framework. Annotations were reviewed and cross-verified by two additional experts, resolving disputes on ambiguous relationships, similar relationship types (e.g., “owns” vs. “hosts”), and unclear entity classifications. These datasets provide comprehensive STIX-compliant annotations essential for evaluating and fine-tuning models for threat intelligence extraction. Details are summarized in Table 1.

| | | Avg. Word per | | |
|---|---|---|---|---|
| Dataset | Text Passages | Text Passage | Entities | Relations |
| AZERG Data | 170 | 102.76 | 2041 | 1073 |
| AnnoCTRPlus | 744 | 23.56 | 1970 | 1002 |

### Model Fine-Tuning

Large language models (LLMs) are often post-trained with custom datasets to enhance their ability to handle diverse instructions, resulting in models referred to as chat or instruct models. While these models excel at understanding human intentions and executing general tasks, they may underperform in specialized tasks due to insufficient task-related data in their pre-training corpus or significant deviation from tasks encountered during post-training. To address this, few-shot prompting, which incorporates a small number of task-specific examples into the instruction, can rapidly adapt these models to specialized tasks. The evaluation of open- and closed-parameter models, such as GPT40 and Mistral-7B-Instruct-v0.3, demonstrated task performance (T1-T4) with F1-scores ranging from 0.15 to 0.77.

To further enhance performance, continual fine-tuning was employed on post-trained open models using the curated dataset of STIX annotations. This approach produced both task-specific models for T1-T4 and a comprehensive model specializing in all four tasks. For base model selection, six instruction-tuned models—including Google's Gemma-2-9b-it, Alibaba's Qwen2-7B-Instruct, Meta's Llama-3.1-8B-Instruct, Shanghai AI Lab's InternLM2 5-7b-chat, Mistral AI's Mistral-7B-Instruct-v0.3, and Microsoft's Phi-3-mini-instruct—were fine-tuned using AZERG data. While Gemma-2-9b-it initially performed best, the Mistral-based model outperformed others after further task-specific fine-tuning, becoming the final base model.

Fine-tuning strategies varied across tasks. For T1 and T2, models were provided with definitions of STIX entity types and examples to detect entity names (T1) and classify extracted entities (T2). For T3 and T4, prompts included possible entity relationship types along with “is not related to” and “not sure” options, enabling the model to determine relationships (T3) and identify their types (T4). The fine-tuning process used the training split of the curated dataset (approximately 70/30 split) with non-overlapping training and testing reports, ensuring no data contamination. Vendors and campaigns from the testing set were also excluded from the training data to provide an accurate evaluation of real-world performance.

Train and Test Split. The dataset is divided into non-overlapping training and testing splits at both the report and campaign levels to ensure robust evaluation. Although AnnoCTRPlus comprises 120 CTI reports compared to AZERG's 21, the number of entities and relationships in both datasets is comparable. This suggests that AnnoCTR utilized shorter and partially annotated reports, potentially capturing fewer complex objects and relationship types. Additionally, the text passages containing STIX objects in AnnoCTRPlus are shorter, as indicated in Table 2, providing less contextual detail.

To accurately evaluate real-world precision and recall for entities and relationships in full reports, 11 AZERG Data reports were designated for testing, while the remaining 10 were used for training. This split ensured vendor-level separation, with the training set containing reports from three vendors and the test set from eight non-overlapping vendors. Further precautions were taken to prevent contamination by excluding malware campaigns in the training set from the test set.

The training split includes 2,664 entities and 1,510 entity relationships across 806 text passages from 130 CTI reports, while the test split comprises 1,347 entities and 565 relationships within 108 text passages, representing 33.58% of all entities and 27.22% of all relationship objects. This dataset, annotated according to the STIX standard, is the largest publicly available of its kind. Table 2 summarizes the total STIX annotations and associated text contexts.

| | | Avg. Word per | | |
|---|---|---|---|---|
| Dataset | Text Passages | Text Passage | Entities | Relations |
| Train | 806 | 35.5 | 2664 | 1510 |
| Test | 108 | 244.0 | 1347 | 565 |
| Total | 914 | 59.69 | 4011 | 2075 |

### Entity Identification Task

The performance of the fine-tuned models on tasks T1-T4 was evaluated. During testing, each text passage from the test split was processed individually for extraction. Models were prompted to perform each task using the same templates applied during fine-tuning. The model outputs were compared to ground truth data to compute precision, recall, and F1-scores.

Results are reported for task-specific models, denoted as AZERG-S-T*, where the asterisk represents the task number, as well as for the AZERG-MixTask model, which was fine-tuned on a combined dataset used for the specialized models. Additionally, comparative results from post-trained large language models, such as GPT40 and Mistral, and state-of-the-art methods for each task are provided.

Entity Detection (T1): The performance results for entity detection (T1), a foundational task in threat knowledge extraction, are detailed in Table 3. For this evaluation, the models were compared with two state-of-the-art methods and a generic transformer-based model for named entity recognition. To ensure fairness, regular expressions were integrated into both models and all comparative approaches.

| Approach | Precision | Recall | F1-Score |
|---|---|---|---|
| GPT4o | 0.8635 | 0.4930 | 0.6277 |
| Mistral-7B-Instruct-v0.3 | 0.7104 | 0.5003 | 0.5871 |
| AttaKG [31] | 0.3797 | 0.4098 | 0.3941 |
| EXTRACTOR [40] | 0.2640 | 0.3537 | 0.3023 |
| GliNER [46] | 0.2315 | 0.1997 | 0.2159 |
| AZERG-S-T1 | 0.8482 | 0.7611 | 0.8023 |
| AZERG-MixTask | 0.9092 | 0.7880 | 0.8443 |

Entity Types Identification (T2). The results are presented in Table 4. As T2 is not addressed by existing methods, only large language models (LLMs) were evaluated. The fine-tuned models outperformed alternative approaches by a significant margin, exceeding them by at least 20%. Notably, the mixed-task model achieved superior results for T1 (84.43% vs. 80.23% for the task-specific model), while the task-specific model marginally outperformed for T2 (89.23% vs. 88.49%).

| Approach | Precision | Recall | F1-Score |
|---|---|---|---|
| GPT4o | 0.6481 | 0.6481 | 0.6481 |
| Mistral-7B-Instruct-v0.3 | 0.3363 | 0.3363 | 0.3363 |
| AZERG-S-T2 | 0.8923 | 0.8923 | 0.8923 |
| AZERG-MixTask | 0.8849 | 0.8849 | 0.8849 |

### Relation Identification Task

Related Pairs Detection (T3). The fine-tuned models outperformed generic instruction-tuned models, with the mixed-task model showing a 2.3% improvement over GPT4o and a 1.5% advantage over the task-specific model (95.47% vs. 93.97%).

| Approach | Precision | Recall | F1-Score |
|---|---|---|---|
| GPT4o | 0.9234 | 0.9398 | 0.9315 |
| Mistral-7B-Instruct-v0.3 | 0.8873 | 0.9203 | 0.9035 |
| EXTRACTOR [40] | 0.0889 | 0.0917 | 0.0902 |
| GliREL [46] | 0.7168 | 0.1849 | 0.2939 |
| AZERG-S-T3 | 0.9335 | 0.9451 | 0.9393 |
| AZERG-MixTask | 0.9224 | 0.9893 | 0.9547 |

For T4, the models exhibited a significant 13-14% performance margin over GPT4o, with the mixed-task model again slightly surpassing the task-specific model by 1.3%. The AZERG-MixTask model, when combined with AZERG-S-T3, is expected to optimize system performance, though the mixed-task model alone provides an efficient alternative with reduced computational cost.

Overall, the fine-tuned models achieved F1 scores of approximately 84% or higher across all tasks, despite the challenges presented by T1 and T4. The complexity of T1 stems from its open-ended nature, requiring identification of all entities within a passage, which becomes increasingly demanding with higher entity counts. T4's difficulty lies in distinguishing between similar relationships. While GPT4o performed comparably to the models only for T3, a substantial performance gap was evident for other tasks.

Inference Time. Inference times varied depending on task complexity. For T1, which involves extensive entity extraction, the average inference time was 2.57 seconds per query, reflecting its computational demands. In contrast, tasks with more straightforward outputs, such as T2, T3, and T4, demonstrated significantly lower inference times of 1.54, 0.58, and 0.36 seconds per query, respectively, highlighting the system's scalability and efficiency across varying task requirements.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A system for STIX report generation from threat intelligence text, comprising:
a main module, comprising
report parser,
a section splitter,
an entity detection component,
an entity type identification component,
a related pairs detection component,
a relationship types identification component,
a STIX output generator, and
a Human Verification and Feedback module, and
a Fine-tuned Large Language Model (LLM) module with a RegEx engine,
wherein the main module is configured to receive an input,
wherein the main module is in communication with the Fine-tuned Large Language Model (LLM) module,
wherein the main module fuses an output from the Fine-tuned Large Language Model (LLM) module to generate a threat analysis output.

2. The system of claim 1, wherein the main module is model agnostic such that it is configured to communicate with a variety of LLM models in parallel.

3. The system of claim 1, wherein the input is one of a URL, a PDF document, or a text document.

4. The system of claim 1, wherein the report parser is configured to receive the input and convert the input into plain text, wherein the report parser removes all formatting except headings HTML tags from the input, and wherein the report parser converts textual and non-textual content found in CTI reports, tables, and bullet points in the input into plain text.

5. The system of claim 1, wherein the section splitter is configured to receive plain text from the report parser, and wherein the section splitter processes the plain text and segments the plain text into paragraphs using HTML headings to result in a segmented output.

6. The system of claim 1, wherein the entity detection component is configured to receive one of plain text from the report parser or segmented output from the section splitter, wherein the entity detection component identifies the SDOs and SCOs, wherein the entity detection component identifies names of Attack Pattern, Identity, Location, Malware, Threat Actor, Tool, Vulnerability, descriptions of Course of Action objects, and value and sub-type of Indicator objects for SDOs, wherein the entity detection component identifies IP addresses, domain names, hashes, emails, MAC addresses, and URLs for SCOs, and wherein the entity detection component has an identified output.

7. The system of claim 6, wherein the entity detection component is in communication with a plurality of LLMs, wherein the RegEx Engine is a regular expression engine that detects IoCs such as URLs, filenames, IP addresses, domain names, file hashes, MITRE ATT&CK IDs, YARA Rules, and ASNs.

8. The system of claim 1, wherein the entity type identification component is configured to detect entity types such as Attack Pattern, Identity, Location, Malware, Threat Actor, Tool, Vulnerability, descriptions of Course of Action objects, wherein the entity type identification component communicates with the Fine-tuned Large Language Model (LLM) module to determine a correct entity type between multiple type designations to result in a resolved output.

9. The system of claim 1, wherein the related pairs detection component is configured to receive an entity type identified output from the entity type identification component, wherein the related pairs detection component loads a STIX relations matrix that defines valid pair-wise relationships (SROs), wherein the related pairs detection component communicates with the Fine-tuned Large Language Model (LLM) module to determine if two entities are related given the entities' names and types and a text.

10. The system of claim 1, wherein the relationship types identification component, is configured to receive an identified relationship pair from the related pairs detection component, wherein the related pairs detection component loads a STIX relations matrix that defines valid pair-wise relationships types, wherein the relationship types identification component communicates with the Fine-tuned Large Language Model (LLM) module to determine if the relationship type between two entities given the entities' names and types and a text.

11. The system of claim 1, wherein the STIX output generator is configured to receive a STIX relations matrix that defines valid pair-wise relationships (SROs), wherein the STIX output generator merges the STIX relations matrix to generate a JSON file encompassing entities and their relations in STIX format.

12. The system of claim 11, wherein the JSON file is the threat analysis output.

13. The system of claim 1, wherein the Human Verification and Feedback component is configured to receive the output of entity detection component, entity type identification component, and the related pairs detection component, wherein the Human Verification and Feedback component allows users to edit the outputs of entity detection component, entity type identification component, and the related pairs detection component.

14. A system for STIX report generation from threat intelligence text, comprising:
a main module, comprising
report parser,
a section splitter,
an entity detection component,
an entity type identification component,
a related pairs detection component,
a relationship types identification component, and
a STIX output generator, and
a Fine-tuned Large Language Model (LLM) module with a RegEx engine,
wherein the main module is configured to receive an input,
wherein the main module is in communication with the Fine-tuned Large Language Model (LLM) module,
wherein the main module fuses an output from the Fine-tuned Large Language Model (LLM) module to generate a threat analysis output.

15. The system of claim 14, wherein the report parser is configured to receive the input and convert the input into plain text, wherein the section splitter is configured to receive the plain text from the report parser, wherein the entity detection component is configured to receive one of the plain text from the report parser or segmented output from the section splitter, wherein the entity detection component has an identified output, wherein the related pairs detection component is configured to receive an entity type identified output from the entity type identification component, wherein the relationship types identification component, is configured to receive an identified relationship pair from the related pairs detection component, wherein the related pairs detection component loads a STIX relations matrix that defines valid pair-wise relationships (SROs), wherein the related pairs detection component loads a STIX relations matrix that defines valid pair-wise relationships types, wherein the STIX output generator is configured to receive the STIX relations matrix that defines valid pair-wise relationships (SROs), and wherein the STIX output generator merges the STIX relations matrix to generate a JSON file encompassing entities and their relations in STIX format.

16. The system of claim 15, wherein the report parser removes all formatting except headings HTML tags from the input, wherein the report parser converts textual and non-textual content found in CTI reports, tables, and bullet points in the input into the plain text, wherein the section splitter processes the plain text and segments the plain text into paragraphs using HTML headings to result in the segmented output, wherein the entity detection component identifies the SDOs and SCOs, wherein the entity detection component identifies names of Attack Pattern, Identity, Location, Malware, Threat Actor, Tool, Vulnerability, descriptions of Course of Action objects, and value and sub-type of Indicator objects for SDOs, wherein the entity detection component identifies IP addresses, domain names, hashes, emails, MAC addresses, and URLs for SCOs, wherein the entity type identification component is configured to detect entity types such as Attack Pattern, Identity, Location, Malware, Threat Actor, Tool, Vulnerability, the descriptions of Course of Action objects, wherein the entity type identification component communicates with the Fine-tuned Large Language Model (LLM) module to determine a correct entity type between the multiple type designations to result in a resolved output, wherein the related pairs detection component communicates with the Fine-tuned Large Language Model (LLM) to determine if two entities are related given the entities names and types and a text, and wherein the relationship types identification component communicates with the Fine-tuned Large Language Model (LLM) to determine if the relationship type between two entities given the entities names and types and a text.

17. A method of generating a STIX report from threat intelligence text, the method comprising:
receiving an input in a report parser,
converting the input into a plain text in the report parser,
receiving the plain text from the report parser in a section splitter,
segmenting the plain text into a segmented output in the section splitter,
receiving one of the plain text from the report parser or the segmented output from the section splitter in an entity detection component,
identifying one of the plain text or the segmented output into an identified output in the entity detection component,
receiving the identified output from the entity detection component in an entity type identification component,
identifying an entity type identified output in the entity type identification component,
receiving the entity type identified output in a related pairs detection component,
identifying an identified related pair in the related pairs detection component,
receiving the identified related pair in a relationship types identification component,
loading a STIX relations matrix to a STIX output generator, and
merging the STIX relation matrix in the STIX output generator to generate a JSON file.

18. The method of claim 17, wherein the input is one of a URL, a PDF document, or a text document.

19. The method of claim 17, wherein the JSON file is a threat analysis output.

20. The method of claim 17, further comprising a Human Verification and Feedback component receiving an output of the entity detection component, the entity type identification component, and the related pairs detection component, wherein the Human Verification and Feedback component allows users to edit the outputs of entity detection component, entity type identification component, and the related pairs detection component.
